(19) United States
(12) Patent Application Publication
(10) Pub. No.: US 2021/0233332 A1
(43) Pub. Date: Jul. 29, 2021

(54) REPRINTS AND REFUNDS OF INDICIA

(71) Applicant: Neopost Technologies, Bagneux (FR)

(72) Inventors: Kirk Lane Wilson, Stratford, CT (US); Cindy Mangiameli, Southbury, CT (US)

(21) Appl. No.: 16/750,769

(22) Filed: Jan. 23, 2020

(51) Int. Cl. G07B 17/00; G06Q 20/40; G06Q 10/08

(52) U.S. Cl. CPC G07B 17/00314; G07B 17/00435; G07B 17/00024; G07B 2017/00338; G06Q 10/083; G07B 2017/00064; G06Q 20/407

(57) ABSTRACT

Systems and techniques are provided that allow for efficient and simple provision of reprint indicia, refund requests and refunds for erroneous or damaged indicia, and combinations thereof, without the technical and administrative overhead common to conventional postage systems.

### BACKGROUND

Systems that use value-bearing indicia, such as postal and other mail delivery systems, often have complex rules regarding when an indicia can be refunded or reprinted. Such rules often are viewed as necessary to prevent unintentional duplication and intentional misuse of the system. For example, if reprints are available without limitation, a user may unintentionally or fraudulently print many shipping labels using the same indicia, which would result in significant losses or administrative overhead for the associated carrier.

### BRIEF SUMMARY

Embodiments disclosed herein include methods and systems for providing reprints and/or refunds of indicia, which include the features of determining that a shipping label comprising an initial indicia did not print correctly and determining whether a reprint and/or refund of the shipping label is available. Where a reprint of the initial indicia is available, an option may be presented to a user to reprint the shipping label and, in response to the user selecting the option to reprint the shipping label, a request for a reprint indicia may be sent to a postage system and the reprint indicia may be received from the postage system. The system then may attempt to print the shipping label using the reprint indicia instead of the initial indicia. Where a reprint of the initial indicia is not available, it may be determined that a refund of the initial indicia is available from the postage system, and the ability to process a refund for the initial indicia may be provided to the user.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example arrangement of systems and devices according to an embodiment of the disclosed subject matter.

FIG. 2 shows an example process according to an embodiment of the disclosed subject matter.

FIG. 3 shows an example computer architecture suitable for implementing embodiments of the disclosed subject matter.

### DETAILED DESCRIPTION

Some shipping and postage systems address or avoid the problem of managing the availability of reprints and/or refunds of indicia by charging a sender of a mailpiece only when the mailpiece enters a mail stream or equivalent delivery stream. For example, carriers such as FedEx, UPS and the like provide online systems through which a sender can print a shipping label that includes an indicia. The sender is charged for the shipment when the associated package or other mailpiece is received by the carrier and begins transit to a recipient. If the sender reprints and re-uses the same indicia, the carrier may charge the sender for each use. The carrier therefore avoids any shortfall or administrative overhead involved in tracking potentially erroneous indicia reprints.

In contrast, pre-paid systems may charge the sender when the indicia is generated. Conventional devices typically remove funds from an account of the sender when an indicia is generated. For example, a conventional franking machine may increment a descending register when an indicia is generated. If the user is allowed to re-print the indicia on demand, it may be possible for the user to use multiple copies of the indicia without incurring a charge for each one. Techniques to address this potential issue include checking or tracking each indicia as it enters the mail stream, which leads to significant technical and administrative overhead. Otherwise the carrier may be open to significant losses if indicia are fraudulently or erroneously reprinted. Another technique is to require the sender to provide the first copy of the indicia to the carrier to obtain permission to reprint the indicia or a refund for the indicia. Such techniques incur significant administrative overhead for both the carrier and the sender. Similarly, pre-paid systems may require significant technical and/or administrative overhead to allow for senders to request and obtain refunds for mis-printed, failed, or unused indicia. For example, the carrier may require a sender to provide the physical mis-printed indicia in order to obtain a complete refund.

Due to the restrictions common when printing postage indicia, an individual sender who encounters a problem when printing indicia may have significant difficulty in printing a replacement indicia or obtaining a refund. As such, there is a need for simplified and improved systems and techniques for more efficient management of reprints and refunds of indicia in systems such as those managed by the USPS and similar carriers.

Embodiments disclosed herein address such needs by providing systems and techniques that allow for simplified and efficient management of reprints and refunds for indicia generated by a carrier such as the USPS.

In an embodiment, the management of reprints and/or refunds of indicia may be managed by automatically determining a reprint is available for a given indicia, and, if not, automatically processing a refund for the initial request and then issuing a new indicia request to the carrier using the same parameters as for the original indicia.

In an embodiment, a user interface may combine authorization and/or acknowledgement for both actions, i.e., reprinting an indicia and processing a refund for an indicia where a reprint is unavailable, into a single screen or other interface for convenience. As previously disclosed, embodiments disclosed herein may internally determine whether a reprint is available to avoid the step of issuing a reprint request unnecessarily, and such determination may be reflected in the user interface. For example, the interface may indicate whether a reprint of an indicia is available and, if not, also may indicate that a refund request has been submitted to or otherwise is in-process.

According to embodiments disclosed herein, refund and reprint requests may alternate between automatically generating a reprint or processing a refund based on the availability of each. The user interface may allow the user to generate a request for a reprint or a refund, or it may automatically determine a need to generate a reprint or refund, such as by receiving error information back from a printer. The system may provide an option to reprint an indicia if a reprint is determined to be available, for example according to USPS rules and processes for determining if a reprint is available, or based upon a specific request associated with the account used to print the initial indicia. If the user selects a reprint option, the system may issue a request for a reprint from a postage system or other controlling device or entity. If a reprint is not determined to be available, an option to generate a refund request and new indicia request may be made available. If this option is selected by the user, the system may automatically process a refund and generate a new request for a replacement indicia using the information in the prior request for the initial indicia. If a refund is not available, the user may be alerted that neither a reprint nor a refund is not available and the user may be prompted to continue with a new request using the prior request information with the understanding that the user will be charged for the new request.

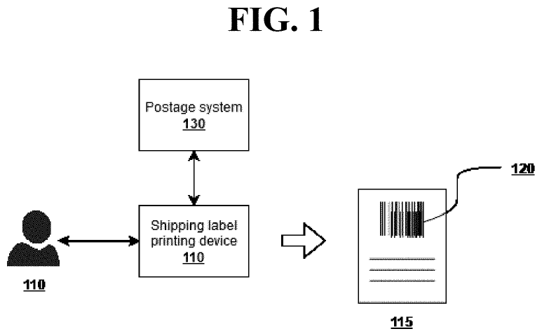

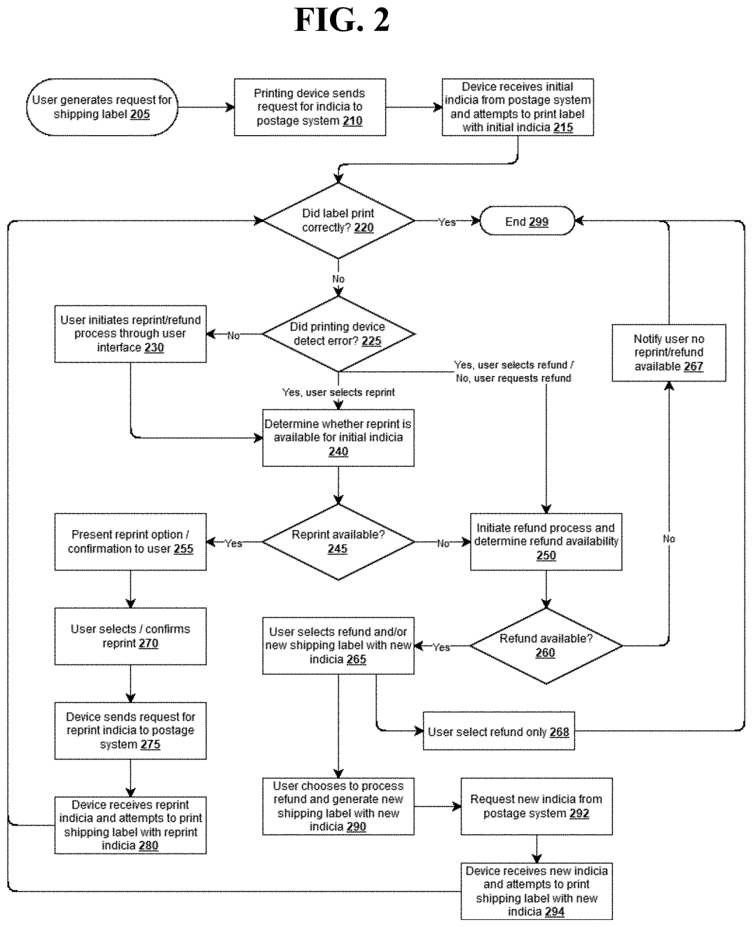

FIG. 1 shows an example arrangement according to an embodiment of the disclosed subject matter. A user 105 may use a shipping label printing device 110, such as a franking machine, a VBI meter device, a general-purpose computer configured to allow users to request and obtain shipping labels, or the like, to print shipping labels 115. Each shipping label 115 may include an indicia 120 that represents funds provided or spent by the user 105 to pay for delivery of a letter, package, or more generally any mail piece by a carrier, such as the USPS, a private carrier, or the like. The shipping label may include other information, or it may consist only of the indicia. The postage system 130 may be one device among many similar devices within the postage system 130, or the device 110 and the postage system 130 may be implemented in one or more common computerized devices. The postage system 130 and device 110 also may be distinct and separate devices and in some embodiments the postage system 130 may be physically remote from the device 110 and user 105. The device 110 may manage funds of the user 105, for example using one or more ascending and descending registers as known in the art. The device 110 also may communicate with a postage system 130 that manages user accounts, generates the indicia 120 upon request from the device 110, and the like, as is understood in the art. However, unlike conventional shipping label printing devices and postage systems, embodiments disclosed herein allow for efficient and simplified generation of reprint indicia and/or refunds of indicia, as described with respect to FIG. 2.

FIG. 2 shows a process for managing reprints and refunds of indicia according to an embodiment disclosed herein. At 205 a user may generate a request for a shipping label using a postage printing device, such as a franking machine or similar device. The shipping label may be only a postage indicia, or it may include additional information or material to be printed at the same time as the indicia. The indicia to be printed on the shipping label may be requested from a postage system at 210, such as a franking machine, a server or service managed by the USPS or another carrier, or any suitable source of indicia. Generally the system will debit or otherwise charge the funds embodied in the indicia to an account of the requesting user, such as by decrementing a descending register in a value-bearing indicia (VBI) meter owned by or otherwise associated with the requesting user, transferring funds from another source owned by the user to a meter that generates the VBI, or otherwise obtaining funds from the user sufficient to allow the indicia to be printed.

At 215, the device used by the user to request the shipping label may receive an initial indicia from the postage system and attempt to print the shipping label including the initial indicia, such as by using an attached or built-in printer. If, at 220, the label is determined to print correctly both by the system and the user, the process may end at 299 and the user may go on to use the shipping label to send a mail piece through the carrier's mail stream in the conventional manner.

However, it is expected that in at least some cases the printer may encounter an error at 220 that may be detected automatically by the postage printing device at 225. For example, the device used by the user to request the shipping label may receive an error message from the printer indicating that the shipping label did not print correctly. The existence of the error may be indicated to the user, such as via an interface as previously disclosed. Some devices may not include functionality that allows for automatic determination that a printing error has occurred. In this case, the user interface may provide a tracking mechanism that indicates the amount of funds and/or the number of reprints or refunds available to the user. This may allow a user to know whether a reprint or refund will be granted before making the request, thereby allowing them to make an informed decision as to how a printing error should be resolved, if at all. A user could also use this information to decide how to respond if an automated refund as disclosed herein is available, or if a refund request will need to be made manually, such as by a conventional approach of physically presenting the erroneous indicia to a post office or the like.

Alternatively or in addition, a device 110 as disclosed herein may include one or more components that allows the user to indicate that a shipping label was requested but did not print, or that there was an apparent printing error. For example, the interface may include a button or other component that the user may actuate to signal to the device that there was a printing error, thereby triggering the reprint and/or refund process beginning at 225. The same component or a separate component may be used to initiate a self-test of the printer to determine if there is a problem with the printer, which also may suspend further printing until the issue is resolved and/or trigger the reprint/refund process. Some such embodiments as disclosed herein may be applicable only to systems in which funds for an indicia are obtained before a shipping label is completely printed, such as where funds are obtained from a user account when the indicia is first generated but before printing the indicia. Systems in which payment is obtained significantly after the indicia is printed, such as when an associated mail piece enters a mail stream, may not have the same need since the user will simply not be charged for an indicia or shipping label including an indicia that fails to print. In contrast, embodiments disclosed herein typically will obtain funds from the user when the indicia is first generated, which generally occurs before the indicia is printed. Embodiments disclosed herein allow for addressing the situation where the indicia is generated and payment is obtained but the indicia fails to print at all, prints partially, prints with an error (such as a smudge, limited ink rendering the indicia unreadable, and the like), or otherwise is unusable before the mail piece is provided to a carrier or otherwise enters the mail stream.

If an error is indicated to the user or if the user independently determines that a printing error has occurred, at 230 the user may manually initiate a reprint and/or refund process, for example by actuating a user interface element such as a physical button, a virtual element of a displayed user interface such as via a touchscreen, or the like.

If the postage printing device automatically identifies an error, and/or if the user identifies an error or otherwise initiates a reprint/refund process at 230, at 240 the device may determine whether a reprint is available. To do so, the device may apply a predefined calculation, such as one defined by a carrier such as the USPS or a provider of the postage system. Such a calculation may depend, for example, on how many indicia the user has printed from the device or an account associated with the user within a certain period of time before the reprint calculation is made, how many total indicia the user has printed, how many reprints and/or refunds have previously been requested and/or provided to the user total or within a period of time, or the like. Alternatively or in addition, the device may query the postage system to determine whether a reprint is available. The postage system may perform the same or a similar calculation, or may use any other suitable technique to determine whether a reprint is available at 245.

If a reprint is available, at 255 the device may present an option to the user to generate a new copy of the same shipping label using a reprint indicia. As used herein and as will be understood by one of skill in the art, a “reprint indicia” refers to a specific form of an indicia that is recognized by the postage system, such as the USPS, as being a reprint of a prior-requested indicia that was damaged, lost, failed during printing, or the like. Typically a reprint indicia will not be an exact copy of the original indicia, but rather will include additional features that allow the postage system to recognize the indicia as a reprint indicia. For example, the reprint indicia may include an additional check digit, hash value, or other identifier that indicates the indicia is a reprint indicia. In contrast to such “reprint indicia,” some systems such as PC-Postage systems may allow for a user to reprint an indicia by simply printing another copy of the indicia. In such an arrangement the PC-Postage provider may assume the risk that a user may erroneously or fraudulently reprint an indicia when a reprint is not necessary and use both copies of the indicia. The use of a “reprint indicia” as disclosed herein may be used, in conjunction with the processes disclosed herein, to reduce or prevent the occurrence of such repeated indicia use.

The user may select the option to generate a replacement shipping label with a reprint indicia at 170, at which point the device may send a request for the reprint indicia to the postage system. Upon receiving a request for a reprint indicia from a device, the postage system may independently verify that a reprint is available. For example, if the calculation to determine that a reprint should be available at 245 is performed by the shipping label printing device without querying the postage system, the postage system may be configured to perform the same calculation to verify that a reprint indicia is available. If the postage system determines that a reprint is available, at 280 the device may receive the reprint indicia from the postage system and attempt to print the replacement shipping label using the reprint indicia.

If the shipping label with the reprint indicia prints correctly, the process ends. Otherwise the process may repeat, or the printing device may determine that there is a recurring or unaddressed error that is preventing correct printing, and provide an alert to the user indicating that the device is malfunctioning and further printing may be disabled.

Referring again to step 225, if an error is detected, instead of proceeding to the reprint process at 240, the device may initiate, or may give the user an option to initiate, a refund process at 255. The refund process beginning at 255 also may be initiated automatically or in response to a user request where it is determined at 240 that a reprint is not available.

Initially, the device may determine if a refund is available at 255. At 260, if a refund is available, the refund process may continue; otherwise at 267 the device may inform the user that no refund is available. Where the device previously determined that a reprint is not available, the user may be informed that neither a reprint nor a refund is available, and the process may end 299. In this case the user may elect to print an entirely new shipping label with a new indicia.

The determination of whether a refund is available may proceed in much the same way as the determination of whether a reprint is available as previously disclosed. That is, the shipping label printing device and/or the postage system may perform a calculation to determine whether a refund is available for the initial indicia that the device attempted to print at 215. The calculation may depend on, for example, on how many indicia the user has printed from the device or an account associated with the user within a certain period of time before the refund calculation is made, how many total indicia the user has printed, how many reprints and/or refunds have previously been requested and/or provided to the user total or within a period of time, or the like. Alternatively or in addition, the printing device may query the postage system to determine whether a refund is available, at which point the postage system may perform the same or a similar calculation.

If a refund is determined to be available at 260, at 265 the device may present the user with an option to process a refund for the initial indicia, i.e., to receive a refund of the amount deducted from an account of the user and forego use of the initial indicia without obtaining a reprint indicia for the initial indicia. The user may elect only to obtain a refund at 268, at which point the refund may be processed and the process ends 299. To provide a refund, the amount of funds used to generate the indicia may be returned to the account or device that initially generated the indicia, a check or other payment may be provided to the user, or, more generally, the amount of funds used to generate the indicia may be returned to the user that requested the indicia by any appropriate means. The final point at which the user receives the funds may occur some time after the refund is processed according to systems and techniques disclosed herein, and additional steps may occur. For example, in some cases an additional approval of the USPS or other carrier may be required, or there may be a delay between when the refund is processed as shown and described and when the user actually receives a refund amount in their account, meter register, or the like.

Alternatively, the user may elect to process the refund and also generate a new shipping label using a new indicia at 190. The new indicia may be identical to the initial indicia or it may be different, depending upon rules, procedures, and requirements of the postage system. If the user elects to print a new shipping label using the new indicia, at 192 the shipping label printing device may request the new indicia from the postage system. The device also may debit an account of the user for the funds used to generate the new indicia, for example by adjusting one or more registers of a VBI meter device associated with the user. The charge for the new indicia may be independent of the refund. That is, the user may be required to pay for the new indicia regardless of when or whether the refund is processed and the refund amount is provided to the user. Alternatively, in an embodiment the refund may be processed prior to obtaining the funds for the new indicia from the user.

At 194, the shipping label printing device may receive the new indicia from the postage system and attempt to print the shipping label using the new indicia. The process then may repeat by returning to step 120 to determine whether the new shipping label including the new indicia printed correctly. As previously disclosed, if there is a recurring problem with printing the new shipping label, the device may forego or prevent further printing attempts and notify the user of a potential problem.

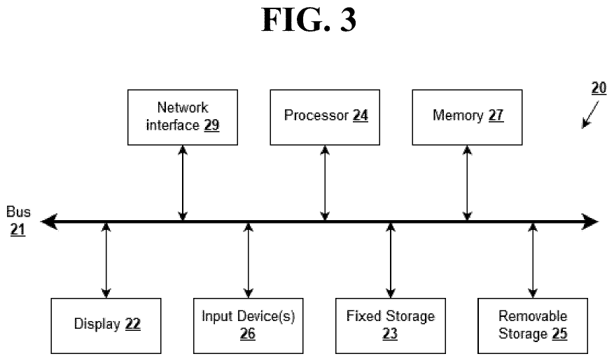

Embodiments of the presently disclosed subject matter may be implemented in and used with a variety of component and network architectures. FIG. 3 is an example computing device 20 suitable for implementing aspects of the presently disclosed subject matter as previously disclosed, such as a personal computing device, a server, a computerized postage printing (“PC postage”) device, or the like. The device 20 may be, for example, a desktop or laptop computer, a mobile computing device such as a phone or tablet, or the like, or it may be such a device embedded in a kiosk, shipping label printing device, or the like. The device 20 may include a bus 21 which interconnects major components of the computer 20, such as a central processor 24, a memory 27 such as Random Access Memory (RAM), Read Only Memory (ROM), flash RAM, or the like, a user display or other output device 22 such as a display screen, one or more user input devices 26, which may include one or more controllers and associated user input devices such as a keyboard, mouse, touch screen, and the like, a fixed storage 23 such as a hard drive, flash storage, and the like, a removable storage unit 25 operative to control and receive an optical disk, flash drive, and the like, and a network interface 29 operable to communicate with one or more remote devices via a suitable network connection.

The bus 21 allows data communication between the central processor 24 and one or more memory components. Applications resident with the computer 20 are generally stored on and accessed via a computer readable medium, such as a fixed storage 23 and/or a removable storage 25 such as an optical drive, floppy disk, or other storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, Wi-Fi, Bluetooth®, near-field, and the like. For example, the network interface 29 may allow the computer to communicate with other computers via one or more local, wide-area, or other communication networks. Other components may be included and some described components may be omitted without departing from the scope or content of the disclosed embodiments. For example, in embodiments in which the disclosed systems and methods are embodied in a postage meter, the meter may include one or more ascending and/or descending registers as is understood in the art.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general-purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
determining that a shipping label comprising an initial indicia did not print correctly;
determining whether a reprint of the shipping label is available;
where a reprint of the initial indicia is available:
presenting an option to a user to reprint the shipping label;
in response to the user selecting the option to reprint the shipping label, sending a request for a reprint indicia to a postage system;
receiving the reprint indicia from the postage system; and
attempting to print the shipping label using the reprint indicia instead of the initial indicia;
where a reprint of the initial indicia is not available:
determining that a refund of the initial indicia is available from the postage system; and
processing a refund of the initial indicia to the user.

2. The method of claim 1, further comprising:
determining that an error occurred during an attempt to print the shipping label;
wherein the step of determining whether a reprint of the shipping label is available is performed in response to a determination that the error occurred.

3. The method of claim 1, further comprising:
receiving a request to initiate a reprint or refund of the shipping label from a user.

4. The method of claim 1, further comprising, where the reprint of the initial indicia is not available:
presenting an option to the user to print the shipping label including a new indicia in addition to processing the refund;
in response to receiving a selection of the option to print the shipping label using the new indicia, sending a request for the new indicia to the postage system;
receiving the new indicia from the postage system; and
printing the shipping label with the new indicia.

5. The method of claim 1, further comprising, where the reprint of the initial indicia is available:
where the attempting to print the shipping label using the reprint indicia is unsuccessful:
determining that a refund of the initial indicia is available from the postage system; and
processing a refund of the initial indicia to the user.

6. The method of claim 5, further comprising, where the reprint of the initial indicia is available and the attempting to print the shipping label using the reprint indicia is unsuccessful:
presenting an option to the user to print the shipping label including a new indicia in addition to processing the refund;
in response to receiving a selection of the option to print the shipping label using the new indicia, sending a request for the new indicia to the postage system;
receiving the new indicia from the postage system; and
printing the shipping label with the new indicia.

7. The method of claim 1, wherein the step of determining that the shipping label comprising the initial indicia did not print correctly comprises:
receiving, from the user, an indication that an error occurred during printing of the shipping label comprising the initial indicia.

8. The method of claim 1, wherein the step of determining that the shipping label comprising the initial indicia did not print correctly comprises automatically determining that a printing error occurred.

9. A system comprising:
a printer capable of being configured to print shipping labels;
a user interface;
a computer-readable memory; and
a processor configured to execute instructions stored on the computer-readable memory which, when executed by the processor, cause the system to:
determine that a shipping label comprising an initial indicia was not printed correctly by the printer;
determine whether a reprint of the shipping label is available;
where a reprint of the initial indicia is available:
present an option to a user, via the user interface, to reprint the shipping label;
in response to the user selecting the option to reprint the shipping label, send a request for a reprint indicia to a postage system;
receive the reprint indicia from the postage system; and
attempt to print, via the printer, the shipping label using the reprint indicia instead of the initial indicia;
where a reprint of the initial indicia is not available:
determine that a refund of the initial indicia is available from the postage system; and
process a refund of the initial indicia to the user.

10. The system of claim 9, wherein the instructions, when executed by the processor, further cause the system to:
determine that an error occurred during an attempt to print the shipping label by the printer;
wherein determination of whether a reprint of the shipping label is available is performed in response to a determination that the error occurred.

11. The system of claim 9, wherein the instructions, when executed by the processor, further cause the system to:
receive a request from the user, via the user interface, to initiate a reprint or refund of the shipping label.

12. The system of claim 9, wherein the instructions, when executed by the processor, further cause the system, where the reprint of the initial indicia is not available, to:
present, via the user interface, an option to print the shipping label including a new indicia by the printer in addition to processing a refund;
in response to receiving a selection of the option to print the shipping label using the new indicia, sending a request for the new indicia to the postage system;
receiving the new indicia from the postage system; and
printing the shipping label with the new indicia by the printer.

13. The system of claim 9, wherein the instructions, when executed by the processor, further cause the system, where the reprint of the initial indicia is available, to:
where the attempting to print the shipping label using the reprint indicia is unsuccessful:
determine that a refund of the initial indicia is available from the postage system; and
process a refund of the initial indicia to the user.

14. The system of claim 13, wherein the instructions, when executed by the processor, further cause the system, where the reprint of the initial indicia is available and the attempting to print the shipping label using the reprint indicia is unsuccessful, to:
present, by the user interface, an option to the user to print the shipping label including a new indicia in addition to processing a refund;
in response to receiving a selection of the option to print the shipping label using the new indicia, send a request for the new indicia to the postage system;
receive the new indicia from the postage system; and
print, by the printer, the shipping label with the new indicia.

15. The system of claim 9, wherein the step of determining that the shipping label comprising the initial indicia did not print correctly comprises:
receiving, by the user interface, an indication that an error occurred during printing of the shipping label comprising the initial indicia.

16. The system of claim 9, wherein the step of determining that the shipping label comprising the initial indicia did not print correctly comprises automatically determining, by the processor, that a printing error occurred.
